(19) United States
(12) Patent Application Publication
(10) Pub. No.: US 2014/0245169 A1
(43) Pub. Date: Aug. 28, 2014

(54) USER PREFERENCE AND CAPABILITY PROFILE

(71) Applicant: LENOVO (SINGAPORE) PTE. LTD., Singapore (SG)

(72) Inventor: Xin Feng, Arcadia, CA (US)

(73) Assignee: Lenovo (Singapore) PTE. Ltd., Singapore (SG)

(21) Appl. No.: 13/775,490

(22) Filed: Feb. 25, 2013

(51) Int. Cl. G06F 3/01

(52) U.S. Cl. CPC G06F 3/01
USPC 715/745

(57) ABSTRACT

An aspect provides a method, including: receiving an identification at a device having a user interface that accommodates at least one modifiable accessibility setting; in response to receiving the identification identifying a user preference and capability profile, loading the user preference and capability profile identified using the identification; and modifying one or more accessibility settings of the user interface in accordance with one or more user preference and capability profile settings of the user preference and capability profile. Other aspects are described and claimed.

### BACKGROUND

Information handling devices (“devices”) come in a variety of forms, for example desktop and laptop computing devices, tablet computing devices, kiosks, smart phones, e-readers, MP3 players, and the like. Many such devices are configured for use with applications that a user interfaces with. User interfaces attempt to take into account accessibility issues.

With user interface technologies such as voice, touch, haptic and so on quickly being adopted by mainstream electronic and information technology (E&IT) products or devices, there is a growing challenge and increased significance to providing a comprehensive accessibility solution. Accessibility solutions should not only be convenient for users but also take into account compliance with public procurement requirements, e.g., Section 508 of the Rehabilitation Act of 1973, as amended in 29 U.S.C. §794 (d), EU Mandate 376, etc.

Individual assistive-technology (AT) solutions have been offered, ranging from screen readers, screen magnifiers, voice-based solutions, and caption services. E&IT product vendors have also implemented accessibility features inside the system, such as MICROSOFT accessibility features and IOS accessibility features.

### BRIEF SUMMARY

In summary, one aspect provides a method, comprising: receiving an identification at a device having a user interface that accommodates at least one modifiable accessibility setting; in response to receiving the identification identifying a user preference and capability profile, loading the user preference and capability profile identified using the identification; and modifying one or more accessibility settings of the user interface in accordance with one or more user preference and capability profile settings of the user preference and capability profile.

Another aspect provides an information handling device, comprising: one or more processors; one or more communication modules; a user interface that accommodates at least one modifiable accessibility setting; and a memory operatively coupled to the one or more processors that stores instructions executable by the one or more processors to perform acts comprising: receiving an identification at the communication module; in response to receiving the identification identifying a user preference and capability profile, loading the user preference and capability profile identified using the identification; and modifying one or more accessibility settings of the user interface in accordance with one or more user preference and capability profile settings of the user preference and capability profile.

A further aspect provides a program product, comprising: a storage medium having computer program code embodied therewith, the computer program code comprising: computer program code configured to receive an identification at a device having a user interface that accommodates at least one modifiable accessibility setting; computer program code configured to, in response to receiving the identification identifying a user preference and capability profile, load the user preference and capability profile identified using the identification; and computer program code configured to modify one or more accessibility settings of the user interface in accordance with one or more user preference and capability profile settings of the user preference and capability profile.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device and components thereof

FIG. 2 illustrates another example information handling device and components thereof

FIG. 3 illustrates an example operating environment for using a user preference and capability profile (UPCP).

FIG. 4 illustrates an example method of using a UPCP.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Many user interface technologies require more sophisticated sensory and/or motor capabilities from the user. One example is multi-touch input, which requires good coordination and precise timing from multi-finger input provided by the user. Multi-touch input can be a great challenge for people with certain types of motor impairment, among others. With what started as a “consumerization” trend, the application of sophisticated user interfaces including such technologies as voice and multi-touch inputs has taken hold not only in consumer products (e.g., smart phones, tablets and the like) but have also been increasingly incorporated into business and government products, such as all-in one computers and so on.

Several public procurement legislative initiatives are under either major update or development. The Rehabilitation Act (U.S. Section 508 law), being a prime example, is under refresh and is being significantly expanded in terms of its original scope and coverage. The E&IT products, which are currently compliant with the current Section 508 requirement, may not support or fully support the refreshed Section 508 requirements. Even if E&IT products offer accessibility-compliant solutions, such products may require extensive steps to setup these features for a given user based on his or her unique capabilities, preferences, etc. While a home user can take the time to setup these accessibility features at home, for devices used in a public environment (e.g., a computer for user self-registration at Social Security Administration, an ATM, etc.), this is almost impossible. Different users may use the same device and thus the user preferences and capabilities frequently change. This in turn requires a quick way to share and apply accessibility settings based on user preference and capability.

Current assistive technologies have some limitations. For example, the current assistive technologies do not share a common way to describe a user's preferences and capabilities. Moreover, existing assistive technologies do not have a common way to share a user's preferences and capabilities settings with various E&IT products and devices. Thus, devices cannot use such preference and capability settings to setup accessibility settings.

Accordingly, embodiments provide mechanisms allowing users to quickly avail themselves of customized accessibility settings. Embodiments leverage a user profile to introduce user preference and/or capability information to E&IT devices (hereinafter simply “devices” or “information handling devices”). Using a user profile, the devices may be quickly customized to a user's needs and/or desires in terms of accessibility settings. Moreover, using a standardized profile and interface, embodiments provide a mechanism by which device and product producers can ensure compliance with various governing laws and regulations regarding accessibility.

The illustrated example embodiments will be best understood by reference to the figures. The following description is intended only by way of example, and simply illustrates certain example embodiments.

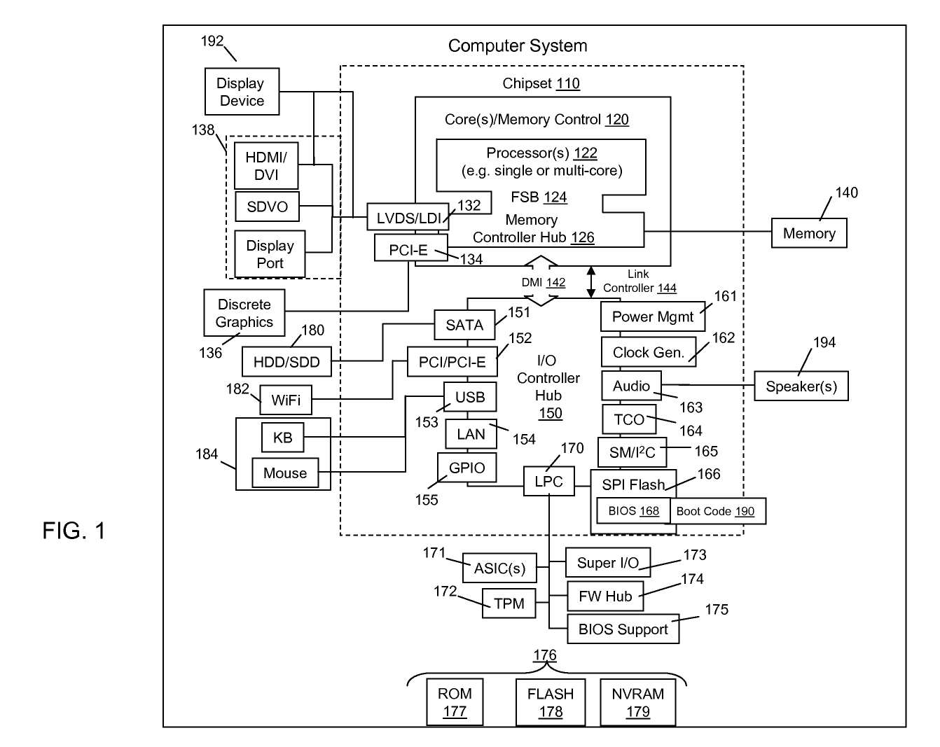

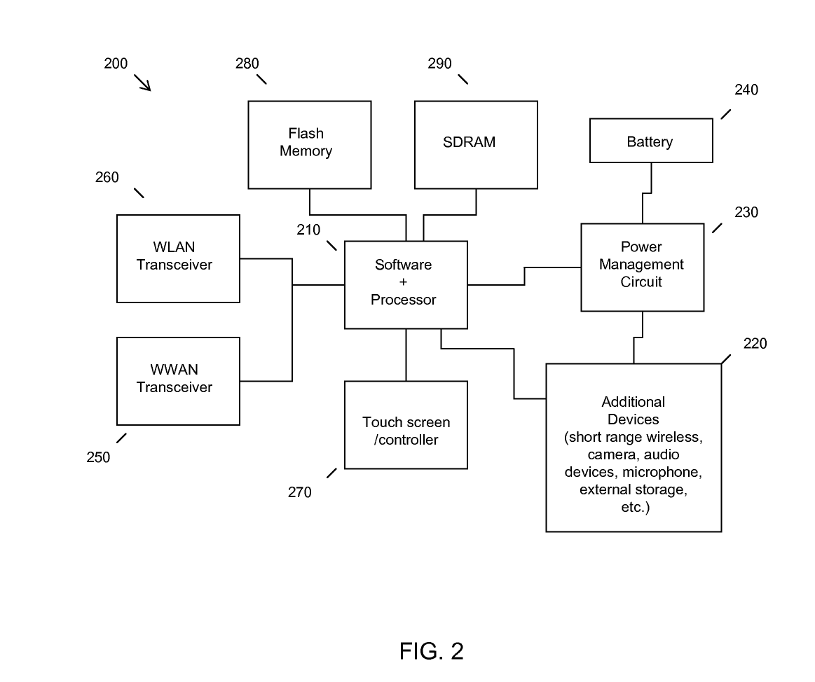

Referring to FIG. 1 and FIG. 2, while various other circuits, circuitry or components may be utilized in information handling devices, with regard to smart phone and/or tablet circuitry 200, an example illustrated in FIG. 2 includes an ARM based system (system on a chip) design, with software and processor(s) combined in a single chip 210. Internal busses and the like depend on different vendors, but essentially all the peripheral devices (220) may attach to a single chip 210. In contrast to the circuitry illustrated in FIG. 1, the tablet circuitry 200 combines the processor, memory control, and I/O controller hub all into a single chip 210. Also, ARM based systems 200 do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

ARM based systems 200 typically include one or more of a WWAN transceiver 250 and a WLAN transceiver 260 for connecting to various networks, such as telecommunications networks and wireless base stations. Commonly, an ARM based system 200 will include a touch screen 270 for data input and display. ARM based systems 200 also typically include various memory devices, for example flash memory 280 and SDRAM 290.

FIG. 1 depicts a block diagram of another example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, which may be used in connection with managing battery cells, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may provide user interfaces that are customized based on accessibility profiles. Thus, embodiments provide mechanisms for providing accessibility profiles to information handling devices, examples of which are outlined in FIG. 1 and FIG. 2.

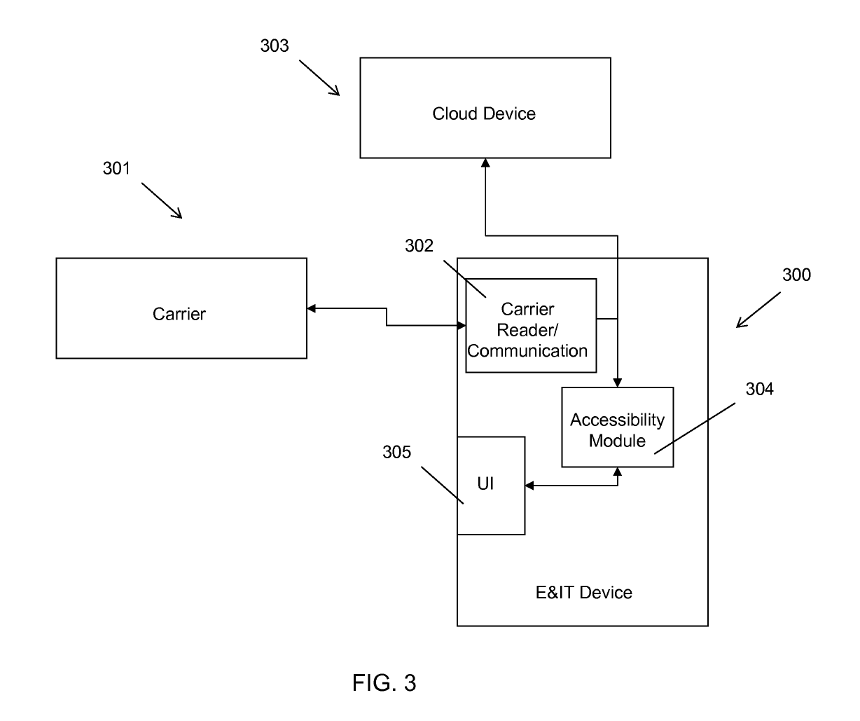

Referring to FIG. 3, embodiments provide a carrier 301 that stores user accessibility information or information useful in deriving the same. The carrier 301 carries the user preference and capability profile (UPCP) information, or information to access the UPCP, e.g., unique user identification number. Examples of a carrier 301 include but are not limited to a smart phone; a smart card; a key chain attached card; or an assistive technology (AT) device.

The UPCP may be provided as a device-independent XML profile. The UPCP may cover user capability and preference information, including an extensibility feature. Because additional information may be included in the profile, and the profile generally may be re-structured, the UPCP permits coverage of any additional accessibility requirements, for example as included in the Section 508 refresh and the like.

Examples of information included in the UPCP include but are not limited to: vision, limited vision, perception of color, auditory (e.g., hearing, limited hearing, speech), limited manipulation, limited reach and strength, photosensitive seizure trigger, literate, and language preference. The information may be included in a Boolean format (e.g., vision) or may be included in another format, e.g., list type for language preference.

The carrier 301 may communicate (e.g., be “read” by a carrier reader 302) and share the UPCP with the E&IT device 300. Examples of communication channels between carrier 301 and E&IT device 300 that may be utilized include but are not limited to the following channels: near field communication (NFC) pairing and communication; and BLUETOOTH communication. Other communication arrangements may be utilized, however. For example, a short-range communication between the carrier 301 and the E&IT device 300 may initiate a protocol whereby the E&IT device 300 identifies and retrieves a UPCP. For example, UPCP profile information may be stored locally at E&IT device 300 or stored on another, remote device such as a cloud device 303, connected to the E&IT device 300, e.g., via an Internet and/or telecommunications network. Thus, the UPCP can be saved on the carrier device 301 or on some other storage (e.g. cloud-based storage device 303). In a cloud-based storage case, the carrier 301 may first establish the pairing with the E&IT product 300 and then the paired E&IT product 300 may retrieve the UPCP from the specified storage 303 via an appropriate communications module, e.g., accessibility module 304.

After retrieving the UPCP, the accessibility engine (e.g., accessibility module 304) in the E&IT product 300 may process the UPCP, e.g., as retrieved from a cloud device 303. The UPCP may thus be used to change the E&IT system 300 accessibility settings based on the UPCP settings. In essence, E&IT product 300 may turn on or otherwise modify the accessibility settings for users, e.g., with special accessibility needs or preferences, based on user-customized UPCP settings. Some examples include but are not limited to the following modifications to a user interface (UI) device 305 of the E&IT device 300.

Vision: when the UPCP value is set to true, then the E&IT product 300 provides at least one mode of operation that does not require user vision to interact with the UI 305 and the E&IT device 300 sets up that mode of operation to be effective. Thus, a user that cannot or does not wish to use vision-based user interface 305 features might use non-vision based user interface 305 features to interact with the E&IT product 300.

Limited Vision: when the UPCP value is to true, where a visual mode of operation is provided, E&IT product 300 provides at least one mode of operation that magnifies the field of vision required to interface with UI 305, one mode that reduces the field of vision required to interface with UI 305, and one mode that allows user control of contrast of the UI 305. Thus, a user that can utilize vision based user interface 305 features and choose to do so, e.g., by indicating as much in the UPCP information, the E&IT product 300 sets up these modes of operation to be effective.

Perception of Color: when UPCP value is set to true, where a visual mode of operation is provided, the E&IT product 300 provides at least one mode of operation that does not require user perception of color for interface with the UI 305. Thus, for a user that cannot or does not wish to utilized color based user interface 305 features, the UPCP indicates as much and instructs the E&IT product 305 to set up non-color modes of operation to be effective.

Limited Manipulation: when the UPCP value is set to true, where a manual mode of operation is provided, the E&IT product 300 provides at least one mode of operation that does not require fine motor control or operation of more than one control of UI 305 at the same time. Thus, when a user cannot or does not wish to use manual manipulation user interface 305 features, his or her UPCP can so indicate, and the E&IT product 300 accessibility settings may be modified accordingly.

Language Preference: the UPCP includes a language preference value from a list of available languages. In this case, the E&IT product 300 switches to the user's preference language if it is available for a given E&IT product 300. If no value is chosen by the user, a default value (language) may be included in the UPCP. If no value whatsoever is included in the UPCP, the E&IT product 300 may select a default language.

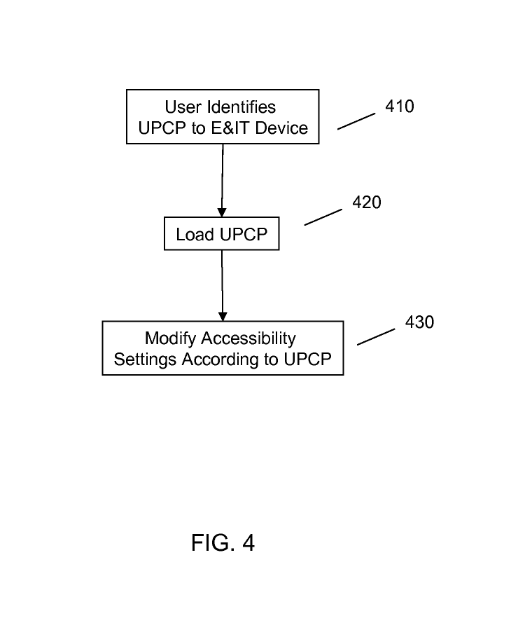

Thus, referring to FIG. 4, embodiments provide a UPCP to an E&IT product such that a user's accessibility preferences may be communicated thereto. In a first step 410, the user identifies the appropriate UPCP to the E&IT device, e.g., via presentation of the carrier 301 to a reader 302 of the E&IT device or product 300.

In a second step 420, in response to being identified, the user's UPCP may be loaded, for example after being retrieved, e.g., either locally (e.g., from the carrier 301) or remotely, e.g., from cloud based storage 303. Again, the user may simply present limited information, e.g., UPCP type “X”, where a limited number of UPCP types are available, rather than presenting a user-specific identification.

Accordingly, on presenting such UPCP selection information, the E&IT product may load a UPCP of type “X”, ether stored locally on the E&IT device, stored on the carrier, or stored remotely (e.g., in cloud based storage). In the latter examples, appropriate communication mechanisms may be employed to retrieve and load the UPCP, e.g., short range or near field wireless communications, or Internet or telecom (network) based communications. In response to retrieving and loading the UPCP, in a step 430, the E&IT device modifies the accessibility settings, e.g., via modifying appropriate UI features to be compliant with information supplied by UPCP.

In an embodiment, the UPCP may be structured as a tree-based profile wherein top level information may be supplemented with increasingly refined information, e.g., as progressing from a root node to leaf nodes. Thus, in an example, the UPCP may take the form of an XML document wherein the top level or root information of the UPCP indicates accessibility settings are contained therein. The subsequent leaf nodes may include increasingly refined information, e.g., vision, color vision, etc. As will be appreciated by those having ordinary skill in the art, providing such a UPCP permits a uniform mechanism for accessing user accessibility preferences and requirements. Moreover, such a structured UPCP permits supplementing or modifying the UPCP as needed, e.g., upon update of legal requirements or industry standard updates. Thus, a single UPCP format may be adopted by the various E&IT providers to ensure compliance with regulatory requirements and with confidence that the UPCP will be enduring by virtue of its ability to be easily updated and modified.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the functions/acts specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving an identification at a device having a user interface that accommodates at least one modifiable accessibility setting;
in response to receiving the identification identifying a user preference and capability profile, loading the user preference and capability profile identified using the identification; and
modifying one or more accessibility settings of the user interface in accordance with one or more user preference and capability profile settings of the user preference and capability profile.

2. The method of claim 1, wherein receiving an identification at a device comprises employing one of near field communication and short range wireless communication.

3. The method of claim 2, wherein the identification is received from a user carrier device.

4. The method of claim 3, wherein the user carrier device comprises one of a smart phone; a smart card; a key chain attached card; a tablet device; a personal assistance device; and an assistive technology (AT) device.

5. The method of claim 1, further comprising, in response to receiving the identification identifying a user preference and capability profile, retrieving a user preference and capability profile using the identification, wherein the user preference and capability profile is retrieved from a memory of the device.

6. The method of claim 1, further comprising, in response to receiving the identification identifying a user preference and capability profile, retrieving a user preference and capability profile using the identification, wherein the user preference and capability profile is retrieved from a user carrier device.

7. The method of claim 1, further comprising, in response to receiving the identification identifying a user preference and capability profile, retrieving a user preference and capability profile using the identification, wherein the user preference and capability profile is retrieved from a remote device using a network connection.

8. The method of claim 1, wherein the user preference and capability profile includes one or more indications of accessibility preferences selected from the group of vision, literacy, auditory, motor-capability, and mobility.

9. The method of claim 1, wherein the identification comprises a user specific identification.

10. The method of claim 1, wherein the identification comprises a user preference and capability profile type identification.

11. An information handling device, comprising:
one or more processors;
one or more communication modules;
a user interface that accommodates at least one modifiable accessibility setting; and
a memory operatively coupled to the one or more processors that stores instructions executable by the one or more processors to perform acts comprising:
receiving an identification at the communication module;
in response to receiving the identification identifying a user preference and capability profile, loading the user preference and capability profile identified using the identification; and
modifying one or more accessibility settings of the user interface in accordance with one or more user preference and capability profile settings of the user preference and capability profile.

12. The information handling device of claim 11, wherein receiving an identification comprises employing one of near field communication and short range wireless communication.

13. The information handling device of claim 12, wherein the identification is received from a user carrier device.

14. The information handling device of claim 13, wherein the user carrier device comprises one of a smart phone; a smart card; a key chain attached card; a tablet device;
a personal assistance device; and an assistive technology (AT) device.

15. The information handling device of claim 11, wherein the acts further comprise, in response to receiving the identification identifying a user preference and capability profile, retrieving a user preference and capability profile using the identification.

16. The information handling device of claim 5, wherein the user preference and capability profile is retrieved from a user carrier device.

17. The information handling device of claim 15, wherein the user preference and capability profile is retrieved from a remote device using a network connection.

18. The information handling device of claim 11, wherein the user preference and capability profile includes one or more indications of accessibility preferences selected from the group of vision, literacy, auditory, motor-capability, and mobility.

19. The information handling device of claim 11, wherein the identification comprises one or more of a user specific identification and a user preference and capability profile type identification.

20. A program product, comprising:
a storage medium having computer program code embodied therewith, the computer program code comprising:
computer program code configured to receive an identification at a device having a user interface that accommodates at least one modifiable accessibility setting;
computer program code configured to, in response to receiving the identification identifying a user preference and capability profile, load the user preference and capability profile identified using the identification; and
computer program code configured to modify one or more accessibility settings of the user interface in accordance with one or more user preference and capability profile settings of the user preference and capability profile.
